(19) United States
(12) Patent Application Publication
(10) Pub. No.: US 2002/0147790 A1
(43) Pub. Date: Oct. 10, 2002

(54) System for presenting designated websites or content to specified users

(76) Inventor: Andrew J. Snow, Darien, CT (US)

Correspondence Address: ST. ONGE STEWARD JOHNSTON & REENS, LLC, 986 BEDFORD STREET, STAMFORD, CT, 06905-5619, US

(21) Appl. No.: 09/829,340

(22) Filed: Apr. 9, 2001

Related U.S. Application Data
(60) Provisional application No. 60/236,985, filed on Sep. 29, 2000.

(51) Int. Cl. G06F 15/16

(52) U.S. Cl. 709/217; 709/249

(57) ABSTRACT

A system for providing designated content to specified users comprising a computer having a communications link to the Internet and a database accessible by the computer containing a plurality of content organized by geographic regions. Software executing on the computer operates and maintains a website accessible by users over the communications link. A means for tracing the geographic location of the user is included in the system. Software executing on said computer also retrieves content from the database corresponding to the traced geographic location of the user, and presents the retrieved content to the user on said website over the communications link. The system may also operate and maintain a plurality of websites wherein each of the websites contain content specific to a designated geographic region or automatically redirect the user to a website containing the location-specific content.

### PRIOR APPLICATION

This application claims benefit of U.S. Provisional Patent Application Serial No. 60/236,985 filed Sep. 29, 2000.

### FIELD OF THE INVENTION

The invention relates to a system for tracking the location of a user of a website and presenting the user with designated content or a designated website based upon the determined location.

### BACKGROUND OF THE INVENTION

The Internet has become a primary tool for information discovery and retrieval for many people worldwide. Whether the desired information is consumer information or local weather and movie times, more and more people are turning to the Internet to find such information. This has lead to the problem of people having to go through bothersome and time-consuming search engines or the hassle of customizing personalized web pages in order to access the desired information. This is especially true for those seeking localized information that is specific to a geographic location. Often, websites will ask the user to input a zip code or an address in order to retrieve the correct information corresponding to the inputted location of the user. While effective, the extra hassle may lead potential users to seek other sources of the information, such as in a newspaper or over the phone, thus diminishing the effectiveness and usage of many websites on the Internet.

Additionally, the worldwide nature of the Internet has also raised several language barriers that are difficult for users and site operators alike to overcome. Many international websites currently request the user to select the desired language in order to present the user with the website in the correct language. As with localized information, this extra step can often deter potential users of an otherwise useful website. In particular, many large companies with international presences encounter the above difficulty when users from foreign countries access the companies' websites and are required to select a language in order to view the site in their native language.

Another common problem is the existence of generic or well-known domain names that have very limited usability due to the above-mentioned drawbacks. This is especially true in the instance where generic domain names for commonly sought information are used by a single isolated entity. For example, a local dentist's office may have a website utilizing the domain name “dentists.com” to relay information pertinent to its business. Thus, an inexperienced Internet user may seek to find a local dentist by inputting “dentists.com” into their browser, but be directed to the website of a dentist that may be hundreds or thousands of miles away. Additionally, many large companies that are widely franchised or licensed currently rely on the above method of inputting location information to direct users to information pertaining to local sources of the company's products or services. Many such organizations regularly leave it to the discretion of the local source to operate and maintain a website, which often results in a disjointed and confusing hierarchy for the user to navigate to locate content related to the company.

What is desired, therefore, is a system for streamlining the presentation of designated content to specified users of a website. In particular, a system that determines the geographic location of a user of the website and presenting the user with designated content specific to the determined location of the user is desired.

### SUMMARY OF THE INVENTION

It is an object of the invention to provide a system that automatically presents a user of a website with content particular to the user's geographic location.

It is a further object of the invention to provide a system of the above character that determines the geographic location of a user of a website.

It is another object of the present invention to provide a system of the above character that permits multiple related entities to share a common, widely known domain name.

It is yet another object of the invention to provide a system of the above character that determines and provides designated content specific to the user's geographic location.

It is a further object of the invention to provide a system of the above character that redirects the user to a different website containing content specific to the user's geographic location.

These and other objects of the invention are achieved by provision of a system for providing designated content to specified users comprising a computer having a communications link to the Internet and a database accessible by the computer containing a plurality of content organized by geographic regions. Software executing on the computer operates and maintains a website accessible by users over the communications link. A means for tracing the geographic location of the user is included in the system. Software executing on said computer also retrieves content from the database corresponding to the traced geographic location of the user, and presents the retrieved content to the user on said website over the communications link.

In another aspect of the invention, software executing on said computer for operates and maintains a plurality of websites accessible by users over the communications link wherein each of the websites contain content specific to a designated geographic region. The software also determines the proper website to present to the user based on the traced geographic location of the user and presents the proper website to the user over said communications link. In yet another aspect of the invention, the database contains a plurality of Internet addresses corresponding to a plurality of websites operated and maintained by third parties containing content specific to geographic locations. Software executing on the computer retrieves an Internet address from the database corresponding to a website containing content specific to the traced geographic location of the user, and automatically redirects the user to a website corresponding to the retrieved Internet address.

The tracing means may comprise software executing on the computer for tracing a geographic location of a user who accesses the website. Alternatively, the tracing means may comprise global positioning system technology incorporated into a mobile device capable of tracing a geographic location of the device utilizing a global positioning system wherein the mobile device includes wireless Internet capabilities enabling access to the website. The tracing means may further comprise software executing on the computer for determining the location of the user based on the location of the signal tower receiving the communication signal emitted from the mobile device. More precision in the determination of the location in this manner can be achieved by triangulating the location of the mobile device's signal.

The invention and its particular features and advantages will become more apparent from the following detailed description considered with reference to the accompanying drawings.

### BRIEF DESCRIPTION OF THE DRAWINGS

FIG. 1 is a schematic of a system for presenting a user with designated content specific to the user's geographic location in accordance with the invention.

FIG. 2 is a schematic of an embodiment of the system of FIG. 1 wherein users are presented with a designated website specific to the user's geographic location in accordance with the invention.

FIG. 3 is a schematic of another embodiment of the system of FIG. 1 wherein users are redirected to third party website containing content specific to the user's geographic location in accordance with the invention.

### DETAILED DESCRIPTION OF THE DRAWINGS

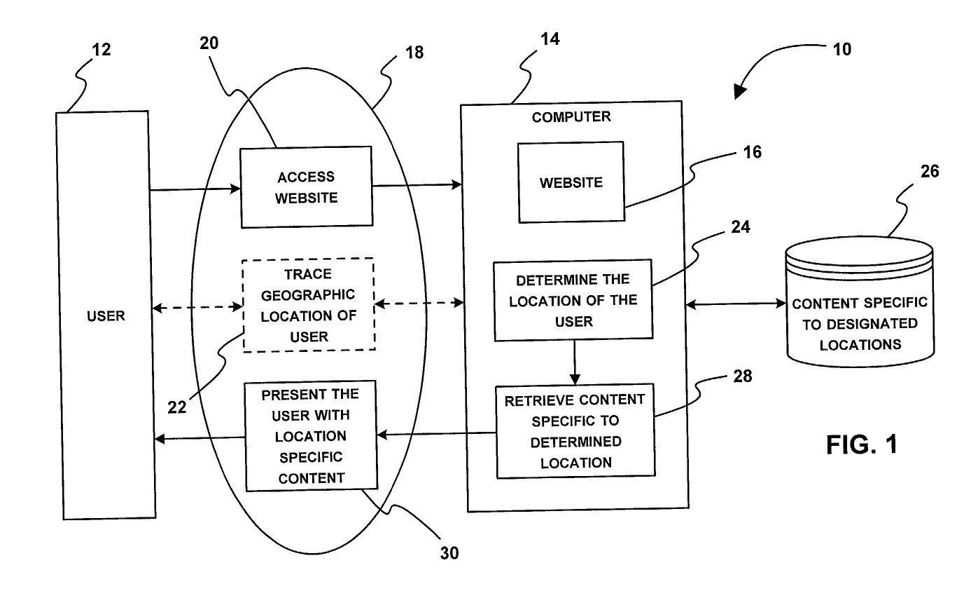

A schematic of the system 10 for presenting a user 12 with designated content specific to the user's geographic location in accordance with the invention is shown in FIG. 1. The system 10 comprises software executing on a computer 14 for hosting and maintaining a website 16 accessible by a user 12 over the Internet. The computer 14 may be any computing device, alone or in combination, such as a personal computer, web server, mainframe, or otherwise that has a communications link 18 to the Internet. The communications link 18 may take the form of any of the currently available means for connecting to the Internet.

Using currently available web-browsing technology, a user 12 may access 20 the website 16 over the Internet. Such browsing technology may include web-browsing software executing on a personal computer connected to the Internet or an Internet-capable handheld device, such as a mobile phone or personal digital assistant (PDA) for example, incorporating wireless Internet technologies. It is understood that there are many means for accessing websites known to those of skill in the art. In the instance of the user 12 gaining access 20 to the website 16 by way of a computer or other Internet-accessing device having a wired connection to the Internet, software executing on the computer 14 traces 22 the geographic location of the user 12. This may be done using any of the currently available technology for tracing a user of a website over the Internet. For example, software executing on the computer 14 may determine the user's geographic location based on the user's Internet Protocol (IP) address. It is to be understood that there are numerous systems and methods known for tracing a user's geographic location via the Internet that may be used in conjunction with the invention.

In the instance of mobile devices, the system may further include software executing on the computer 14 for tracing 22 the user's geographic location based on a signal generated from the mobile device. For example, when a cellular tower picks up the communication signal from the mobile device accessing the website via wireless Internet technologies, software executing on the computer 14 may determine the user's location based on the location of the tower receiving the signal. For greater precision in determining the user's location, the software may triangulate the user's location based on the strength of the communication signal as received by three or more cellular towers. The mobile device could further include a Global Positioning System (GPS) chipset to utilize the Global Positioning Satellite System to determine and track the user's location. Once the location of the device is determined, the location of the user is transmitted to the computer 14 over the communications link 18. It is understood that the location of the user need not be transmitted from the user's mobile device and may actually be provided to the computer 14 by a third-party system that makes the determination. It is to be understood that there are several known systems and methods known for tracing a user's geographic location based on the mobile device's communication signal or through GPS, or any combination thereof, which may be used in conjunction with the invention.

Once the user's geographic location of the user is resolved 24, software executing on the computer 14 queries a database 26 containing a plurality of content specific to particular geographic areas. The location-specific content may include content written in a particular language or content specific to events or services in the determined location of the user 12, for example. It is to be understood that the specific type of content chosen to be presented to users in particular geographic locations is at the discretion of the website operator. The software then retrieves 28 the content corresponding to the determined geographic location from the database 26 and presents 30 the retrieved content to the user 12 on the website 16 via the communications link 18.

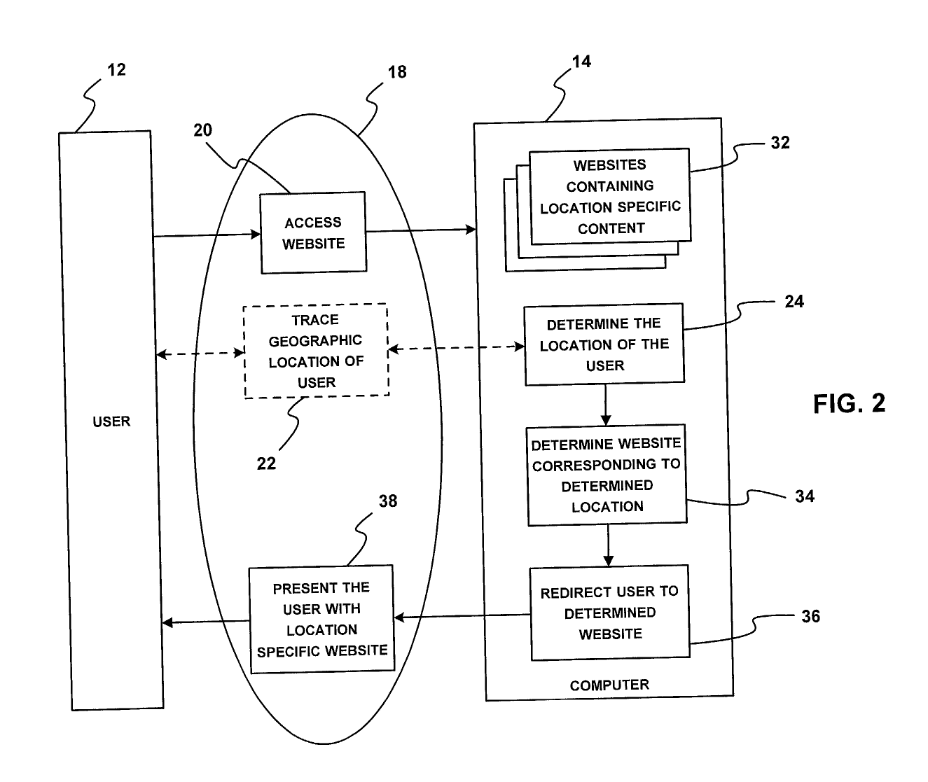

Referring to FIG. 2, an alternate embodiment of the system 10 is shown. Software executing on the computer 14 may operate and maintain a plurality of websites 32. Each of the websites would contain the desired location-specific content to be presented to the users. The user 12 would still access 20 the system 10 using a desired pre-selected domain name. Upon the determination 24, of the user's geographic location, software executing on the computer 14 would determine 34 the proper website corresponding to the determined geographic location of the user 12 and automatically redirect 36 the user 12 to the website containing the location-specific content and present 38 the determined website to the user 12 over the communications link 18. Therefore, through the use of a single desirable domain name, a website operator may maintain a plurality of websites that automatically cater specifically to users of specific geographic locations.

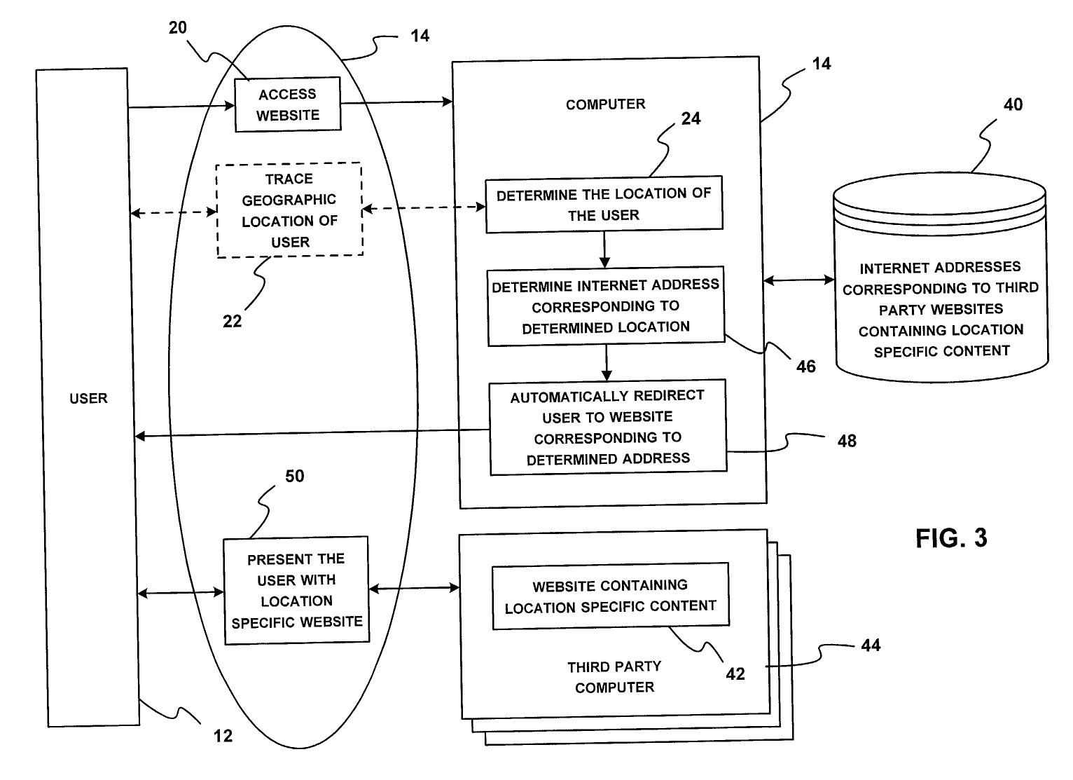

Referring to FIG. 3, another embodiment of the system 10 is shown. In this embodiment, the system 10 includes a database 40 accessible by the computer 14 containing a plurality of Internet addresses corresponding to a plurality of websites 42 operated and maintained by third parties on third party computers 44 wherein each of the plurality of websites 42 contains content specific to predetermined geographic locations. Upon determination 24 of the geographic location of the user 12, software executing on the computer 14 would determine 46 the proper website containing the content corresponding to the determined geographic location of the user 12 and retrieve an Internet address from the database 40 corresponding to the determined website. The software would then automatically redirect 48 the user 12 to the website corresponding to the retrieved Internet address on a third party computer 44.

The system 10 may be used to enable the sharing of domain names. Such would be especially useful for generic domain names for localized services to be utilized by multiple providers in different regions. By way of example, if a user inputted the domain name “dentists.com” in an appropriate web browser, software on the computer hosting the website “dentists.com” would determine the local dentists available based on the user's determined location and present the user with the options. Alternatively, the software may automatically redirect the user to the website of a dentist local to the user based on the determined geographic location. Such a system could also readily permit a company to automatically redirect users to local franchises, licensees or distributors of the company's products or services. For example, a user may enter a restaurant chain's domain name and automatically be presented with the website of the local franchisee of the chain. Thus, the need for the user to access a general website and perform a search based on an inputted location is eliminated since the user's location is determined automatically by the tracing software.

This system may also be useful for presenting the user with content or a website in the user's native language. For example, a French-speaking person may access a website using a computer located in France. Software on the website host computer would trace the user to determine the location of the user. Upon determination that the user's location to be France, software would retrieve and present the user with content in French or direct the user to a website presented in French. This would be especially useful for global companies that have website visitors from around the world. By tracking the location of a user, the system could automatically present the user with the website in a corresponding language depending on the determined location while permitting the company to maintain a single widely-known domain name.

The system 10 may further be used to present users with localized content or information specific to the user's location, such as weather, show times, events, etc. For example, the user may access a website to inquire about movie times in the user's area. Upon determination of the user's location, the user would be automatically presented with the current movies and when and where they may be viewed. The system 10 could also determine possible routes from the user's determined location to the movie theater and present the user with directions and/or maps indicating the routes. Once again, this avoids the step of the user needing to enter their geographic information into a searching program within the site to find the desired information.

Another example of a use for the system 10 would be to permit a company to present certain products and/or advertising campaigns to users from different regions of the country or world. For example, a company may wish to have different marketing campaigns aimed at different regions of the country and thus, upon determination of the location of the user accessing the company's website, the user may be presented with the appropriate campaign based on the determined location. Similarly, the user may be presented with certain products depending on the user's determined location. For example, an automobile company may wish to initially present a user from California with the latest convertible model and present the new pick-up truck to a user in the Midwest. By determining the location of the user and linking certain content to specified locations, the system can readily enable the company to automatically present the desired products and/or advertising web presentations to users from various geographic regions.

Although the invention has been described with reference to a particular arrangement of parts, features, and the like, these are not intended to exhaust all possible arrangements or features, and indeed many other modifications and variations will be ascertainable to those of skill in the art.0

What is claimed is:

1. A system for providing designated content to specified users comprising:
a computer;
a communications link between said computer and the Internet;
a database accessible by said computer containing a plurality of content organized by geographic regions;
software executing on said computer for operating and maintaining a website accessible by users over said communications link,
means for tracing a geographic location of a user who accesses said website; and,
software executing on said computer for retrieving content from said database corresponding to the traced geographic location of the user, and presenting said retrieved content to the user on said website over said communications link.

2. The system of claim 1 wherein said tracing means comprises software executing on said computer for tracing a geographic location of a user who accesses said website.

3. The system of claim 1 wherein the user accesses said website using a mobile device incorporating wireless Internet technology.

4. The system of claim 4 wherein said tracing means comprises global positioning system technology incorporated into said mobile device capable of tracing a geographic location of said device utilizing a global positioning system.

5. The system of claim 4 wherein said tracing means further comprises software executing on said mobile device for utilizing said global positioning system to trace the geographic location of the device and transmitting said determined location to said computer over said communications link.

6. The system of claim 3 wherein said tracing means comprises software executing on said computer for determining the location of said user based on a location of a signal tower receiving a communication signal emitted from said mobile device.

7. The system of claim 6 wherein the location of the user is determined through triangulation of a communication signal emitted from said mobile device.

8. The system of claim 1 wherein each of said plurality of content in said database contains information in a language corresponding to a geographic region by which said content is organized.

9. A system for providing designated content to specified users comprising:
a computer;
a communications link between said computer and the Internet;
software executing on said computer for operating and maintaining a plurality of websites accessible by users over said communications link wherein each of said plurality of websites contains content specific to a designated geographic region;
means for tracing a geographic location of a user who accesses said website; and,
software executing on said computer for determining a website to present to the user based on the traced geographic location of the user, and presenting said determined website to the user over said communications link.

10. The system of claim 9 wherein said tracing means comprises software executing on said computer for tracing a geographic location of a user who accesses said website.

11. The system of claim 9 wherein the user accesses said website using a mobile device incorporating wireless Internet technology.

12. The system of claim 11 wherein said tracing means comprises global positioning system technology incorporated into said mobile device capable of tracing a geographic location of said device utilizing a global positioning system.

13. The system of claim 12 wherein said tracing means further comprises software executing on said mobile device for utilizing said global positioning system to trace the geographic location of the device and transmitting said determined location to said computer over said communications link.

14. The system of claim 11 wherein said tracing means comprises software executing on said computer for determining the location of said user based on a location of a signal tower receiving a communication signal emitted from said mobile device.

15. The system of claim 14 wherein the location of the user is determined through triangulation of a communication signal emitted from said mobile device.

16. The system of claim 9 wherein each of said plurality of websites contains information in a language commonly used in the geographic region to which the website is designated.

17. A system for providing designated content to specified users comprising:
a computer;
a communications link between said computer and the Internet;
a database accessible by said computer containing a plurality of Internet addresses corresponding to a plurality of websites operated and maintained by third parties wherein each of said plurality of websites contains content specific to designated geographic locations;
software executing on said computer for operating and maintaining a website accessible by users over said communications link,
means for tracing a geographic location of a user who accesses said website; and,
software executing on said computer for retrieving an Internet address from said database corresponding a website containing content specific to the traced geographic location of the user, and automatically redirecting the user to the website corresponding to the retrieved Internet address.

18. The system of claim 17 wherein said tracing means comprises software executing on said computer for tracing a geographic location of a user who accesses said website.

19. The system of claim 17 wherein the user accesses said website using a mobile device incorporating wireless Internet technology.

20. The system of claim 19 wherein said tracing means comprises global positioning system technology incorporated into said mobile device capable of tracing a geographic location of said device utilizing a global positioning system.

21. The system of claim 20 wherein said tracing means further comprises software executing on said mobile device for utilizing said global positioning system to trace the geographic location of the device and transmitting said determined location to said computer over said communications link.

22. The system of claim 19 wherein said tracing means comprises software executing on said computer for determining the location of said user based on a location of a signal tower receiving a communication signal emitted from said mobile device.

23. The system of claim 22 wherein the location of the user is determined through triangulation of a communication signal emitted from said mobile device.

24. The system of claim 17 wherein each of said plurality of websites is presented in a language commonly used in the geographic region to which the website is designated.
